(19) United States
(12) Patent Application Publication
(10) Pub. No.: US 2011/0173537 A1
(43) Pub. Date: Jul. 14, 2011

(54) INTEGRATED DATA PROCESSING AND TRANSCRIPTION SERVICE

(75) Inventor: Charles T. Hemphill, Redmond, WA (US)

(73) Assignee: EVERSPEECH, INC., Redmond, WA (US)

(21) Appl. No.: 13/004,779

(22) Filed: Jan. 11, 2011

Related U.S. Application Data
(60) Provisional application No. 61/293,998, filed on Jan. 11, 2010.

(51) Int. Cl. G06F 3/048

(52) U.S. Cl. 715/716; 715/764

(57) ABSTRACT

A system and method are provided herein to support text and data entry for computer applications and the collection, processing, storage, and display of associated text, audio, image, video, and related data.

### CROSS-REFERENCE TO A RELATED APPLICATION

The application claims the benefit of Provisional Application No. 61/293,998, filed Jan. 11, 2010, which is incorporated herein by reference.

### BACKGROUND

Effective speech to text systems can save time and money for various applications. For years, doctors and lawyers have used dictation services of various kinds. Current options include recording audio data for later manual transcription or the use of automated systems. The result is typically a single text document.

Manual transcription solutions have become more accessible in recent years through an increase in the number of ways to submit audio data to a transcription service. Examples include more affordable recording equipment, dedicated telephone numbers, Web audio data submission, and the like. However, the result is typically a separate text document that then must be manipulated and stored appropriately by the recipient.

Automatic machine transcription systems have the potential to create text while the user talks. Such systems have the potential to integrate with general computer applications, but there are limits to the technology. First, correction is nearly always required, and this activity requires a specialized user interface. It often fails to support a simple “fire and forget” solution. Second, automated systems work best when they know about the target domain. They benefit from knowing about any domain-specific vocabulary or word patterns. For example, much effort has been expended to create specialized medical systems, such as for radiologists. Third, automated systems work best in a quiet office environment. This technology often fails for applications such as inspecting noisy equipment or performing tasks near a battlefield.

Gradually, paper forms are being replaced by Web-based forms and user interfaces connecting to databases of various kinds. Additionally, computers are becoming smaller and more mobile, feeding the desire to enter text while away from an office and keyboard. Pen and touch input methods can address some of these needs, but these methods tend to require an additional hand, be relatively slow, and require post-input correction.

Audio data can be recorded and submitted for transcription, but there is currently no general way to associate the resulting text back into the desired context (e.g., a text area or the associated database field). Specialized applications may be created, but there is an ever-growing established base of Web-based applications and database interfaces. A solution is desired that works with current Web and database standards.

In addition to seeing text in a text area, it may be desirable to store and recall the original audio data from which the text was transcribed. Furthermore, it might be advantageous to store and recall image, video, or other data related to the same text area. Current systems do not support this for general applications.

Internet connectivity has increased along with the speed of that connectivity, but it is still not always available in various mobile environments. In remote areas and inside buildings, for example, a method for text entry should preferably work without connection to a network or the Internet.

Additionally, a practical text entry method should preferably be affordable and scalable. It should be possible for individual users to use a solution directly for themselves or involve knowledgeable associates within the same company. In some cases, security may be an issue and sensitive audio data must be retained and transcribed or processed by trusted individuals.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

One aspect of the present subject matter includes a data structure form of the subject matter reciting a computer-readable medium on which data stored thereon are accessible by software which is being executed on a computer, which comprises one or more data structures. Each data structure associates a piece of inchoate user-created content with a user interface element connected with the software. Each data structure persists so as to allow retrieval after the user-created content is transformed from inchoate to formed whether or not a user leaves or returns to the user interface element after navigating away from the user interface element.

Another aspect of the present subject matter includes a method form of the subject matter reciting focusing on a user interface element of software being executed on a computer, capturing a piece of inchoate user-created content initiated by a user, and creating a data structure which associates the inchoate user-created content with the user interface element connected with the software. The data structure persists so as to allow retrieval after the user-created content is transformed from inchoate to formed whether or not the user leaves or returns to the user interface element after navigating away from the user interface element.

A further aspect of the present subject matter includes a system form of the subject matter reciting a computer system, which comprises a transcription computer on which a transcriptionist component executes, a data and transcription server, and a client computer on which a transcriber component and an application execute. The application includes a user interface element, which can be focused to capture inchoate user-created content. The transcriber component creates a data structure which associates the inchoate user-created content with the user interface element connected with the application. The data structure persists so as to allow retrieval after the user-created content is transformed by the transcriptionist component from inchoate to formed whether or not a user leaves or returns to the user interface element after navigating away from the user interface element.

### DESCRIPTION OF THE DRAWINGS

The foregoing aspects and many of the attendant advantages of this subject matter will become more readily appreciated as the same become better understood by reference to the following detailed description, when taken in conjunction with the accompanying drawings, wherein:

FIG. 1 is a block diagram illustrating an archetypical system;

FIGS. 2A-2D are pictorial diagrams illustrating an archetypical user interface;

FIG. 3 is a pictorial diagram illustrating an archetypical user interface; and

FIGS. 4A-4B are pictorial diagrams illustrating an archetypical user interface.

### DETAILED DESCRIPTION

The detailed description that follows is represented largely in terms of processes and symbolic representations of operations by conventional computer components, including a processor, memory storage devices for the processor, connected display devices and input and output devices. Furthermore, these processes and operations may utilize conventional computer components in a heterogeneous distributed computing environment, including remote file servers, computer servers and memory storage devices. Each of these conventional distributed computing components is accessible by the processor via a communication network.

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise.

Various embodiments of an integrated data processing and transcription service may provide a flexible means to associate audio, text, image, video, and other forms of data with text and input fields and their associated database fields. Combined with a command and control speech recognition system, an integrated data processing and transcription service may provide a complete means of entering text and data in general computer-based applications.

In particular, one embodiment of an integrated data processing and transcription service may perform some or all of the following tasks: (1) on a client computer with a Web browser, display a standard Web document from a standard content server and associated content database, the Web document having one or more text areas for accepting text input; (2) using a transcriber component and microphone on the client computer, record audio data associated with a desired text area in the Web document; (3) transmit the recorded audio data, along with user information and user preferences, from the transcriber component to a data-and-transcription server; (4) provide the recorded audio data from the data-and-transcription server to a transcriptionist component; (5) provide transcribed text created by the transcriptionist component from the recorded audio data back to the data-and-transcription server; (6) transmit transcribed text from the data-and-transcription server back to the transcriber component; (7) through the transcriber component, enter the transcribed text into the desired text area; (8) through normal Web technology for form elements, communicate the transcribed text in the desired text area back to the content server and associated content database for storage and later retrieval.

The transcriber component provides a visual interface for collecting audio and other forms of data. It uses focus mechanisms to identify a text area selected by the user. In some embodiments, the transcriber component communicates with the data-and-transcription server through a network (e.g., the Internet, a local or wide-area network, a wireless data network, and the like) to send audio and other forms of data and to retrieve text that may have been transcribed from audio data. The transcriber component also enters the transcribed text back into the selected text area.

The data-and-transcription server provides a means of collecting and storing audio and other data for later retrieval by one or more transcriber components. A transcriptionist component notes the availability of audio data and provides a means of converting this audio data into transcribed text. The transcribed text is then transmitted back to the data and transcription server.

In some embodiments, the client computer is a mobile computer connected to a network. If the client computer is not connected to a network, then the content server and data-and-transcription server may also run on the same client computer. In this case, once the client computer becomes connected to a network, it may then transmit data collected to a remote content server and data-and-transcription server for normal operation. Additionally, the transcriptionist component may also run directly on the client computer to provide transcribed text in a self-contained system without the need to connect to a network.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

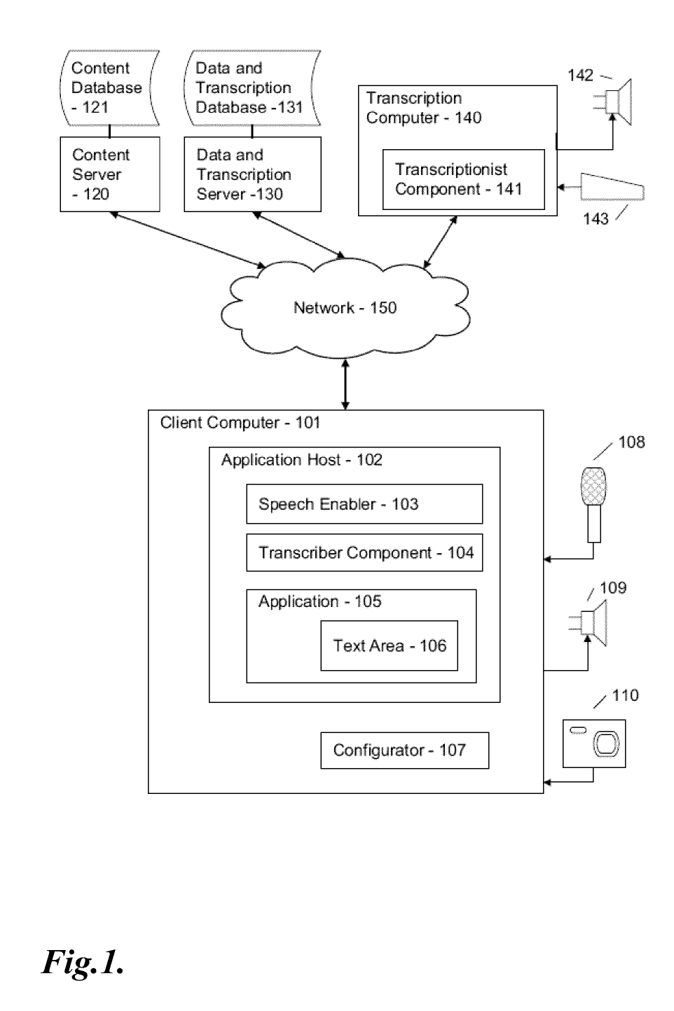

FIG. 1 illustrates an exemplary client computer 101, transcription computer 140, data-and-transcription server 130, and content server 120, all connected to network 150. In various embodiments, network 150 may comprise one or more of the Internet, a local or wide-area network, a wireless data network, and the like.

As shown in FIG. 1, client computer 101 includes sound input 108 and output 109 components, configurator 107, and an application host 102 (e.g., a Web browser), which hosts a user interface such as speech enabler 103, transcriber component 104, and application 105. In one embodiment, application 105 may comprise one or more Web documents that include user interface elements, such as text areas 106 (e.g., Hyper Text Markup Language [“HTML”] textarea elements).

A user may focus on the text area 106 using, for example, a pointing device, speech recognition, or the like. In one embodiment, speech enabler 103 may be implemented as a browser extension, browser add-on, browser helper object, or similar technology. For example, in one embodiment, speech enabler 103 may listen for a label element associated with an HTML textarea element as shown in the following example:

<label for=“id1” class=“SpeakText”>Text Box 1</label>:<br />
<textarea id=“id1” name=“text1” rows=“10” cols=“80”
class=“CommentField”></textarea>

In this example, when speech enabler 103 hears the user speak the words “text box one,” it puts focus on the associated textarea. The “SpeakText” class may, for example, show the associated text with a color or other visual indication indicating that the user may speak the words to activate the textarea.

Once text area 106 gains focus, transcriber component 104 becomes enabled. In various embodiments, the transcriber component 104 may be implemented in several ways including as a part of the speech enabler 103 browser extension, as a separate browser extension, as a Web component (e.g., an Applet invoked by a Web document comprising application 105), and the like.

If transcriber component 104 is implemented as a browser extension, then no change is required to the Web document. However, in this case, installation of a browser extension is required on client computer 101. By contrast, if transcriber component 104 is implemented as, for example, an Applet, then transcriber component 104 may operate on client computer 101 without a separate installation. However, in this case, the Web document may be required to invoke the transcriber component 104 as the Web document loads. Implementing this invocation may be as simple as including one line of JavaScript. The remainder of this description applies to transcriber component 104 regardless of implementation.

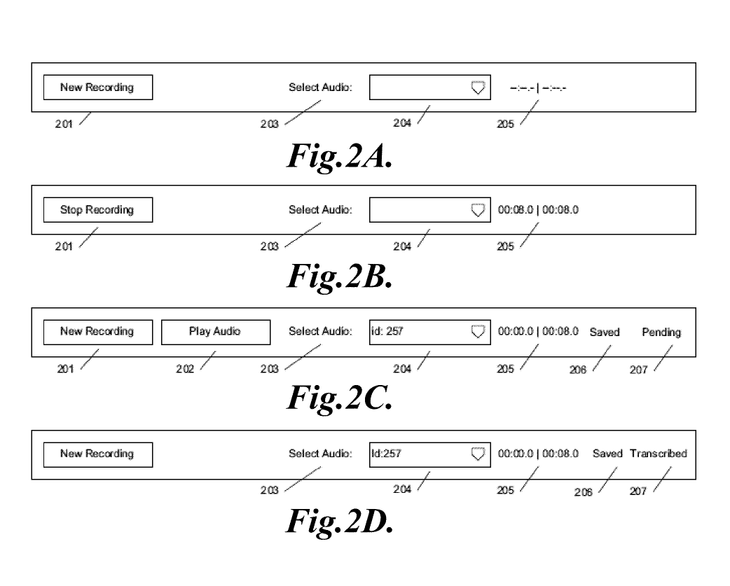

Data Recording: FIG. 2A shows a representation of a GUI/VUI (Graphical User Interface/Voice User Interface) made available to the user once the text area 106 gains focus. To begin recording, action button 201 may be selected by voice (e.g., by saying “New Recording”), by a pointing device, or by other selection method. Label 203 shows the data-selection label (e.g., “Select Audio”) for the data-selection dropdown 204. Initially, dropdown 204 is empty. Status indicator 205 shows the current time within any recorded audio data. The initial time with no recording is represented by dashes.

Once the user selects “New Recording” corresponding to action button 201, recording of audio data begins. As shown in FIG. 2B, action button 201 then changes to “Stop Recording.” Status indicator 205 shows the time position of the current audio data cursor before the vertical bar and the total length of the recorded audio data. While recording, these two times are the same.

Once the user selects “Stop Recording,” via action button 201, recording stops. As shown in FIG. 2C, action button 201 changes again to “New Recording.” Option button 202 now displays “Play Audio.” Dropdown 204 now shows the data ID of the recorded audio data (e.g., “id: 257”). The times in status indicator 205 indicate that the audio data cursor is at the beginning (i.e., “00:00.0”) and the length of the recorded audio data (e.g., “00:08.0”). Status indicator 206 indicates that the audio data is saved, and status indicator 207 indicates that transcription is pending. Transcriber component 104 also adds some text (referred to as a “data crumb”) to text area 106 to associate the data ID and indicate the pending state. For example, in one embodiment, transcriber component 104 inserts the following data crumb into text area 106:

<transcription id=‘257’ status=‘pending’/>

Such data crumbs track the state of data for a given text area 106. In this case, the exemplary data crumb indicates that transcriber component 104 is awaiting a transcription for the recorded audio data.

In one embodiment, the data crumb is inserted into text area 106 as if the user had typed it. Therefore, if text area 106 appears within a form element within a Web document, it will be saved in a content database 121 when the user submits the form data. The form data may be saved, for example, when the user selects a button corresponding to an input element of type “submit,” by JavaScript action when changing to a different Web document, or the like. Additionally, some browsers save the state of data entered in case the user navigates away and returns to the same Web document. In any event, the data crumb represents the persistent status state of the transcription corresponding to the current recording identified with a data ID.

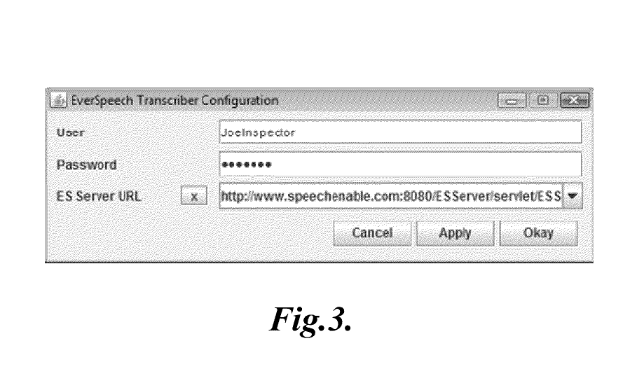

FIG. 3 shows an exemplary configurator 107 GUI. In one embodiment, transcriber component 104 uses user name, password, and other information to connect to a data-and-transcription server 130, given the URL of the data-and-transcription server 130. In one embodiment, this information is stored on client computer 101. In other embodiments, this information may be stored in a network-accessible data store, or obtained from the user via other entry mechanisms. In some embodiments, configurator 107 can also provide digital signature and other authorization information for access permission and secure transmission of data. In other embodiments, configurator 107 can allow the user to change various parameters that affect the behavior of the transcriber component 104 and related components and operations.

Data Communication: Once transcriber component 104 establishes a connection with data-and-transcription server 130, transcriber component 104 requests a data ID. In response, data-and-transcription server 130 records information about a transcription request in data-and-transcription database 131 and creates a data ID. The data ID is unique and may encode information such as the user's identity, the user's company, the user's machine, and the like. In various embodiments, the data ID may be requested before, concurrently, or after the audio data recording illustrated in FIGS. 2A-2D, discussed above. The data ID provides the key for identifying and playing previously recorded audio data using dropdown 204. The data ID is also stored in text area 106 via a data crumb, as described above. While audio data is recording as shown in FIG. 2B, transcriber component 104 transmits audio data to data-and-transcription server 130 using the data ID. In some embodiments, transcriber component 104 may also save a local copy of the audio data to ensure data integrity, for rapid playback, and for potential stand-alone operation. In other embodiments, transcriber component 104 may wait until after recording is complete to transmit audio data to data-and-transcription server 130.

When data-and-transcription server 130 provides the data ID to transcriber component 104, data-and-transcription server 130 may also determine if a transcriptionist component 141 has connected to the data-and-transcription server 130 from a transcription computer 140. If so, data-and-transcription server 130 may notify connected transcriptionist component 141 that audio data is pending transcription.

In various embodiments, all data transferred between all components of the system can be transferred using standard secure connections and protocols.

Data Storage: Once data-and-transcription server 130 begins to receive audio data from transcriber component 104, data-and-transcription server 130 stores the received audio data and notes information about the recording in data-and-transcription database 131. In various embodiments, the audio data may be received via http, https, sockets, voice over IP, or other like method. While audio data is recording, data-and-transcription server 130 sends a request for transcription to connected transcriptionist components 141. If more than one transcriptionist component 141 is available, data-and-transcription server 130 may pick one based on various factors, such as timeliness, cost, load, and the like. Once a transcriptionist component 141 is selected for the given data ID, data-and-transcription server 130 begins to transmit audio data to the selected transcriptionist component 141.

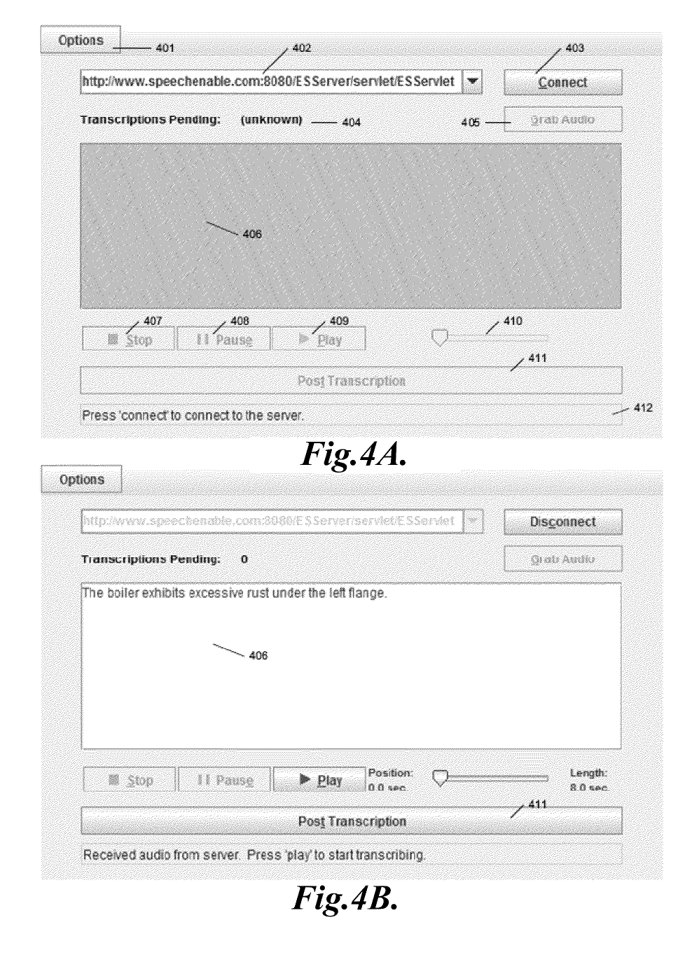

Data Processing: As illustrated in FIG. 4A, transcriptionist component 141 may include a user interface to a human transcriptionist. transcriptionist component 141 provides an options interface via options button 401 to identify the human transcriptionist along with any needed authorization mechanisms. Dropdown 402 selects the desired data-and-transcription server 130 through a URL. Connect button 403 requests a connection to the data-and-transcription server 130. The status text area 412 indicates if the connection request was successful. The transcriptions-pending indicator 404 indicates the number of pending transcriptions on data-and-transcription server 130.

Once connect button 403 is invoked and the connection to data-and-transcription server 130 is successful, the connect button 403 changes to “Disconnect” to disconnect the connection if desired. Once the transcriptions-pending indicator 404 shows a number greater than zero, the grab-audio button 405 becomes available. Once the grab-audio button 405 is selected, audio data begins to play and the stop button 407 and pause button 408 become active. The audio-data slider 410 also becomes active and indicates the relative position in the audio data. Audio-data slider 410 can also indicate the length of the audio data, if available. Once the audio data has played, play button 409 becomes active and stop button 407 and pause button 408 become inactive.

Once audio data begins to play, the human transcriptionist can begin entering text into text area 406 as shown in FIG. 4B. Once the transcription is complete, the human transcriptionist may invoke the post-transcription button 411 to transmit the transcribed text to data-and-transcription server 130 via network 150.

Once data-and-transcription server 130 receives transcribed text from transcriptionist component 141, data-and-transcription server 130 stores the transcribed text in data-and-transcription database 131 so that the transcribed text is associated with the data ID (e.g., id=‘257’) and the original audio data for the recording.

Data Display: When transcriber component 104 determines that a transcription corresponding to a data ID that transcriber component 104 had previously submitted is available on data-and-transcription server 130, transcriber component 104 retrieves the transcribed text and inserts it into text area 106 along with an updated data crumb as in the following illustrative example:

<transcription id=‘257’ status=‘done’>

The boiler exhibits excessive rust under the left flange.

</transcription>

As shown in the example text above for text area 106, the status in the data crumb changes from “pending” to “done.” Also, the status in status indicator 207, FIG. 2D, changes from “Pending” to “Transcribed.”

At this point, the transcribed text is in text area 106 within the data crumb. As a convenience, in one embodiment, speech enabler 103 provides the speech command “clean text,” which removes the data crumb, leaving the transcribed text in text area 106. “Clean text” is an optional command, as it also disassociates the audio data from any transcribed text. In one embodiment, the speech command “restore text” can restore the data crumb if the user has not navigated away from the page or saved the form data. Keeping the data crumb supports later playback of the associated audio data. Other embodiments may use buttons or other GUI elements to activate the “clean text” and “restore text” functionality.

Note that a given text area 106 may contain more than one data crumb with transcribed text. After one recording, the user may again select “New Recording” via action button 201 to start the process with another recording.

After recording an utterance, the user may play an utterance by selecting “Play Audio” with button 202. Once there is more than one recording associated with a given text area 106, the user may select an utterance using the data selection dropdown 204. Playback of audio data may be used instead of or as a backup to a transcription. Playback of audio data may also be used to confirm a transcription.

Data Update and Persistence: There may also be more than one text area 106 within a Web document. As the user changes the focus from one text area 106 to another, the currently focused set of data crumbs also changes. The transcriber component 104 user interface in FIG. 2 updates to reflect the currently focused set of data crumbs. For example, data selection dropdown 204 may update to show the utterances corresponding to the data IDs in the focused text area 106.

Transcriber component 104 may detect a status update from data-and-transcription server 130 for a data crumb within a text area 106 and update that text area while the user remains on the page. For example, if any of the data crumbs contains a “pending” status, transcriber component 104 may check with data-and-transcription server 130 to see if there is a status update. If there is a status update, transcriber component 104 retrieves the associated transcribed text and updates text area 106 as described above. The transcribed text may appear shortly after the user finishes speaking. The transcribed text may also take some time to appear: from seconds, minutes, or in some cases, hours. During this time, the user may navigate away from the current Web document. Navigating away from the page will save the current state of text area 106 and other page elements back on content server 120 and content database 121.

When a user returns to a Web document created by content server 120, including data in content database 121, the Web document can contain one or more data crumbs. If any data crumbs have “pending” status, then, as if the user never left the page, transcriber component 104 checks data-and-transcription server 130 for status updates. If there is a status update, transcriber component 104 retrieves the associated transcribed text and updates text area 106 as described above. Additionally, if the user focuses on a particular text area 106, then the user may select and play previously recorded audio data by selecting it using the transcriber component 104 data selection dropdown 204. Transcriber component 104 will request any needed audio data from data-and-transcription server 130 using the data ID.

Data Processing Flow: FIG. 4 shows an interface for obtaining text from a human transcriptionist. There may be multiple applications 105 on multiple client computers 101. In this case there may be multiple transcriber components 104 interacting with potentially multiple data-and-transcription server 130 computers. Multiple humans may be using multiple transcriptionist components 141. Over time, there will be a flow of audio data recordings available for creating transcriptions from transcriber components 104 to data-and-transcription servers 130 and to transcriptionist components 141. Likewise, there will be a flow of text transcriptions from transcriptionist components 141 to data-and-transcription servers 130 and back to transcriber components 104. When a data-and-transcription server 130 informs a transcriptionist component 141 that an audio data recording is available, an audible beep or visual cue can alert the human transcriptionist that an audio data recording is available, the transcriptions-pending indicator 404 becomes greater than zero, and the Grab Audio button becomes selectable. Since more than one human at a time can “Grab Audio”, the data-and-transcription server 130 decides which transcriptionist component 141 receives the audio data and the other transcriptionist components 141 receive other audio data or return to a waiting state. In a waiting state, transcriptions-pending indicator 404 will be zero and the Grab Audio data button will be unavailable.

When choosing a transcriptionist component 141 to receive recorded audio data, a data-and-transcription server 130 may take several factors into consideration. These factors may include past measures of timeliness, cost, quality, and the like for the transcriptionist component 141. These factors may also include domain knowledge for a particular transcriptionist component 141, including vocabulary and syntax for various application areas if the transcriber component 104 makes this information available to data-and-transcription server 130. Such factors can be matched with information from a configurator 107 to optimize parameters related to transcription for a given user.

A form of “bidding” system may be used to match transcriptionist components 141. For example, some users may be willing to pay more for faster turnaround, and higher rates might entice faster service solutions. Possible user bidding parameters include maximum acceptable fee, maximum wait desired for transcribed text, maximum and minimum quality desired, domain area, and the like. Possible transcriptionist component 141 bidding parameters include minimum acceptable fee, nominal transcription rate, nominal quality rating, areas of domain expertise, and the like.

Transcriber component 104 may provide information to data-and-transcription server 130 to alert transcriptionist components 141 to potential activity and accommodate data flow. In one embodiment, this information may include some or all of the following alert levels: (1) the user is now using an application 105 that contains a text area 106; (2) the user has focused on a text area 106; (3) the user has started to record data using transcriber component 104 for a text area 106; and (4) the user has requested transcribed text for recorded data (the request can be automatic or manual based on a user settable parameter).

There are many alternative implementations of the transcriptionist component 141, including a fully automatic machine transcription system, a human-verified machine transcription system, a manual transcription system, a human-verified manual transcription system, a Web service connecting to a traditional transcription service, and the like.

As previously discussed, many automatic machine transcription systems perform best when trained on the vocabulary and syntax of a target domain. Other relevant training factors include audio data recorded using a particular microphone from a particular hardware system and possibly from a specific user. Over time, significant amounts of audio data recording and associated transcriptions may be collected by data-and-transcription servers 130. When sufficient data is collected for a target domain, this data may be used to create or improve automatic machine transcription systems specialized for a given target domain. Thus, some embodiments may operate initially with the aid of humans and, over time, migrate by degrees to a fully automatic system, while retaining the same system design.

Application Support: As previously described, application host 102 may be a Web browser in some embodiments. In other embodiments, application host 102 may be any application that contains one or more text areas 106 and connects the data in those text areas to a content database 121 or data store in general. In such cases, transcriber component 104 may integrate with application host 102 to generally support text and data entry into text areas 106 for applications 105.

A text area 106 may be embodied as an HTML textarea element, an input element, or any other construct that can contain text. If application host 102 is not a Web browser, then text area 106 may be any component of application host 102 that can contain or store text.

Stand-Alone Operation: As previously discussed, in some cases, client computer 101 may not be connected to network 150 or to other computers at all times. client computer 101 may, for example, be a mobile device (e.g., a laptop, netbook, mobile phone, game device, personal digital assistant, and the like). When client computer 101 is not connected to network 150, content server 120, content database 121, data-and-transcription server 130, and data-and-transcription database 131 may all reside on client computer 101. In some embodiments, when client computer 101 obtains a connection to network 150, client computer 101 may transmit data from local to remote versions of content server 120 and data-and-transcription server 130, providing audio data and retrieving transcribed texts from transcriptionist component 141.

Transcriptionist Location Options: As also discussed above, transcription computer 140 may be the same as client computer 101. In this case, a user may use a local transcriptionist component 141 to provide his or her own transcriptions once client computer 101 is connected to a keyboard 143 or other text input device or system.

Transcription computer 140 and client computer 101 might also both reside within a company intranet. This can add an extra level of security for transcriptions and provide an extra level of domain expertise for the subject vocabulary and syntax. For example, a business entity may provide assistants to transcribe audio for a doctor or lawyer within a given practice. Similarly, a real estate inspection firm or equipment inspection firm might also choose to provide their own transcriptionists within the company. Companies and other entities may choose to provide their own transcriptionist components 141, including, for example, automatic capabilities based on data from their domain.

Data Recording Options: As described above, the GUI/VUI in FIG. 2 depicts one embodiment for recording data. In an alternative embodiment, a user might select “New Recording” to begin recording, but the recording might stop after utterance pause detection. Alternatively, recording might begin once a text area 106 receives focus. In this case, recording might stop when the user selects “Stop Recording”, or pause when utterance pause detection is used, or by any other means that indicates recording should stop. In one embodiment, the various options to start and stop data collection may be controlled by various user or application settable parameters.

Data Persistence Options: As described above, data crumbs are used by transcriber component 104 to associate audio data, the state of that audio data in the transcription process, and the final transcribed text with a particular text area 106. With this approach, transcribed text may be provided for any application 105 with text areas 106, without any change to application 105 or content server 120.

In an alternative embodiment, content server 120 may generate data IDs associated with particular data items in context database 121. In turn, content server 120 may associate these same IDs with text areas 106. For example, an “evsp: transcribe” tag may use the “id” attribute for a data ID and the “for” attribute to identify the ID of the desired textarea element:

<evsp:transcribe for=“id1” id=“257” crumbs=“true”/>
<label for=“id1” class=“SpeakText”>Text Box 1</label>:<br />
<textarea id=“id1” name=“text1” rows=“10” cols=“80”
class=“CommentField”></textarea>

In this case, transcriber component 104 need not ask data-and-transcription server 130 for a data ID, but rather it can use the data ID from the <evsp: transcribe> tag. The remaining functionality of the system remains as described above. If the user focuses on text area 106 with textarea having id “id1”, for example, then the GUI/VUI for transcriber component 104 will appear as before, ready to record audio data. This approach supports the case where content server 120 can directly know about data IDs and request updates directly from data-and-transcription server 130.

If the crumbs option is “true,” data crumbs will be used so that the transcribed text can appear as before in the text area 106. More than one data crumb for a text area can be part of a sequence. If the crumbs option is “false,” transcribed text can appear directly in text area 106. In this case, the presence or absence of transcribed text can indicate the “pending” or “transcribed” status of the text area. This use of data IDs from the server reduces clutter from the user's prospective of having data crumbs in the text areas. On the other hand, seeing the data IDs can help associate data in a text area 106 with data selection dropdown 204 for playback and review.

Alternatively, the “evsp:transcribe” element can also specify a “store” attribute whose value is the ID of a hidden input element:

<evsp:transcribe for=“id1” id=“257” store=“dataCrumbs”/>
<label for=“id1” class=“SpeakText”>Text Box 1</label>:<br />
<textarea id=“id1” name=“text1” rows=“10” cols=“80”
class=“CommentField”></textarea>
<input type=“hidden” id=“dataCrumbs” value=“”/>

In this case, transcriber component 104 can store data crumb information in the specified hidden input element. The same hidden element may be used to store multiple data crumbs from multiple text areas 106.

Data Representation Options: Data crumbs themselves may be represented in a variety of ways, and no particular form or text of a tag is required. In various embodiments, data crumbs may be implemented in SGML, XML, or any other text or binary markup language or representation.

Data crumbs may also include internal information to help users without access to a transcriber component 104. For example, in one embodiment, a data crumb could contain a URL that allows access to the related data, any related information, or that describes how to install and use a transcriber component 104:

<transcription url=‘http://www.everspeech.com/data?id=257’
status=‘recorded’>
[Visit the URL to get audio or text.]
</transcription>

As another example, an application 105 might allow access to information associated with a data crumb through or URL to that information, through a user interface mechanism that displays or renders the information, through direct display in the interface, or the like. As a further example of an embodiment, information associated with a data crumb might be accessed from data and transcription server 130 to include in reports, presentations, documents, or the like.

Data crumbs may also be presented in a variety of ways. The information in the data crumbs may be read by transcriber component 104 from text areas 106, stored internally while application 105 is in view, displayed in an abbreviated form to the user (e.g., data crumb sequences delimited by a line of dashes, blank lines, or the like), and restored back into the internal values of text areas 106 when the user navigates away from text areas 106. This is analogous to an automatic version of the “clean text” and “restore text” commands described previously. In some embodiments, data crumb presentation may be controlled by user or application settable parameters.

Additionally, some embodiments may allow for different data crumb presentation depending on the focus status for text areas 106. For example, “clean text” and “restore text” functionality might apply to a text area 106 having focus, but not other text areas 106. In some embodiments, this option may be controlled by user or application settable parameters.

Updating Data: As discussed above, in various embodiments, transcriber component 104 retrieves transcribed text from data-and-transcription server 130 when text area 106 contains a data crumb with a pending status. However, in some embodiments, the original user of a Web document in application 105 does not revisit the Web document and/or the transcribed text becomes available before the original user revisits the Web document. In such embodiments, an application on content server 120 may proactively identify database values with data crumbs having “pending” status and communicate directly with data-and-transcription server 130 to update the database. Using this approach, the transcribed text may be available the next time a user revisits the Web document and/or when the associated database value in content database 121 is retrieved. Consequently, reports may be generated using application 105 as a means of collecting data rather than as a data integrator (e.g., a report generator).

Alternatively, a separate application on client computer 101 may review data crumbs having “pending” status or those finalized within a given period of time. As a result, a user can determine that, for example, he or she can use application 105 to generate reports, as some or all data represented in data crumbs has been processed (e.g., transcribed text is available for audio data).

Alternative Data: As discussed above, in various embodiments, transcriber component 104 collects audio data from a user and provides a means of producing transcribed text for text area 106. In this case, the data crumbs provide a means of persisting data when the transcribed text is not immediately available, and the user may leave the text area 106 or even the application 105 without losing data.

In other embodiments, data crumbs, along with the related mechanisms previously described, may associate other forms of data with text area 106. For example, in some embodiments, data crumbs may associate image data, video data, GPS data, or other forms of data with a text area 106. In such cases, transcriber component 104 may offer selections such as “Take a picture,” “Capture a video,” “Store time stamp,” “Store my Location,” and the like. For large data sources such as images and video, transcriber component 104 may transmit the data to data-and-transcription server 130 for storage in data-and-transcription database 131. In some embodiments, data-and-transcription server 130 may store the data in the “cloud” for application 105. An application on content server 120 may later retrieve the information from data-and-transcription server 130 and store it in content database 121 for later use with application 105.

A data crumb can associate non-transcribed-text data with a text area 106 as in the following examples:

<image id=‘258’ display=‘below’ />
<video id=‘259’ display=‘below’ />

A user may use configurator 107 to specify the location of the data relative to the text area 106 (e.g., ‘none,’ above, ‘below,’ and the like). In some embodiments, a user can additionally adjust the location via the GUI/VUI in transcriber component 104 or by any other means for setting parameters and options.

In some embodiments, small data input values may be embedded in the data crumb. For example, in one embodiment, GPS information and/or time information may be stored in a data crumb as follows:

<gps lat=“37.441” lng=“−122.141” />
<time date=“12/30/2009” time=“14:12:23” />

In some embodiments, a user may request via configurator 107 that information such as time, location, and the like be automatically associated with other data crumbs, such as audio, images, and video.

In some embodiments, the user may further combine different types of information to, for example, use transcribed text from audio data to label image or video data.

In some embodiments, data may not require the use of transcriptionist component 141 and may instead be stored in data-and-transcription database 131 by data-and-transcription server 130. In other embodiments, transcriptionist component 141 may transcribe or produce text from, derived from, or representing image and/or video data. In such embodiments, the transcription produced by transcriptionist component 141 may include more than just text. For example, the transcription may also include time encoding information reflecting where the words from the transcribed text occurred in the video data. In some cases, such time-encoded transcribed text may be too voluminous to display in text area 106, and an abbreviated form may be stored in text area 106, while data-and-transcription server 130 stores the complete transcription. Thus, the time-encoded transcribed text may facilitate later searches of the video data.

In some embodiments, user or application settable parameters may control when, where, and how to display alternative data. For example, a user may or may not wish to see time information associated with a data crumb by default. Additionally, some embodiments might support interactive voice commands such as “show time information” or other means to control when, where, and how alternative data is displayed.

Data Processing Options: FIGS. 2C and 2D show status indicators/buttons 206 and 207. As discussed above, in various embodiments, audio data is automatically saved and transcribed. In some embodiments, automatically saving audio data may include streaming the audio data to transcriptionist component 141 for near-real-time transcription.

The GUI/VUI of transcriber component 104 can also provide data processing status updates such as completion estimates for transcribed text based on the user's preference choices (e.g., cost and quality) and transcriptionist component 141 match and availability.

In some embodiments, configurator 107 may include an option to “transcribe.” For example, while recording in transcriber component 104, upload the data to data-and-transcription server 130 and transmit to transcriptionist component 141 if possible. In other embodiments, configurator 107 may include an option to “upload.” For example, while recording, upload, but wait for the user to explicitly select “Transcribe” via button 207 before transmitting to transcriptionist component 141. The user may thus have the opportunity to avoid charges associated with transcriptionist component 141 should he or she wish to cancel and/or re-record. In still other embodiments, configurator 107 may include an option such as “none.” For example, record locally, but do not upload the audio. The user can manually select “Save” via button 206 and “Transcribe” via button 207. The user may thus flexibly determine whether to commit to processing the data just recorded. Thus, in some embodiments, the GUI/VUI of transcriber component 104, configurator 107, or the like may flexibly support options to control when to upload, save, transcribe or otherwise manipulate data. In some embodiments, the decision of when to process the data, including the transcription, may be delayed to an entirely different application 105 or application host 105 or on a different client computer 101 or other content server 120 in general.

Other status options are possible for indicator/button 207 and information in the associated data crumb. As discussed above, in various embodiments, indicator/button 207 may reflect status states such as “Pending,” “Transcribed,” and the like. In other embodiments, status states may include “Recorded” to indicate that audio has been recorded, but there has not been a request to further process the data as described in the previous paragraph. In other embodiments, status states may also include “Preliminary” to indicate that the current transcribed text may change. For example, transcriptionist component 141 may use an automatic machine transcription as a first pass, followed by manual correction from a human transcriber associated with the transcriptionist component 141 (or with a second transcriptionist component 141) as a second pass. In other embodiments, the first pass could also be performed by a human—either the same human as that performing the second-pass correction or another human.

In some embodiments, the user may manually edit and/or correct transcribed text in a data crumb associated with a text area 106. In such cases, transcriber component 104 may detect the manual changes and transmit them to data-and-transcription server 130. In some embodiments, such manual correction data may be used to rate and/or improve the people and/or technology associated with transcriptionist component 141.

In some cases, a “collision” or conflict may arise when the user manually edits and/or corrects the transcribed text while the status is “Preliminary.” In such cases, transcriber component 104 may detect the conflict and offer to resolve it with the user.

Conclusions: There has been a steady move to replace paper forms with computer-based forms, especially with Web-based forms and on mobile computers. Various embodiments may fill a missing gap in the user interface for many applications, allowing a user to enter arbitrary text and data into an application in an easy, simple, and accurate fashion.

Various embodiments may be used in applications including inspections for real estate, construction, industrial machinery, medical tasks, military tasks, and the like. Users who specialize in these and like areas may need to collect data in the field, but cannot afford to do post-field tasks such as re-entering hand written information, associating text and data together and in the right location within the application. In some cases, such users may currently abbreviate or entirely skip this kind of data entry due to the difficulty involved.

Other embodiments may be used in applications including entering text within specific text boxes in general applications on the Web (e.g., blog input, comment input, and the like). In such cases, a user may choose to enter text according to methods discussed herein and/or such a system might be sponsored by hosting companies or other companies.

For example, a user may visit a Web page having one or more comment boxes. The page may include a transcriber component 104 implemented as an Applet (no installation required), so the user can simply record his or her comment. In one embodiment, the user's comment may be transcribed and properly entered into a database associated with the Web page. In some embodiments, the transcribed comment may be further associated with related information, such as the user's identity, the date/time, the user's location, and the like. The user may see his or her comment transcribed during the current or a subsequent visit to the Web page. Alternately, the transcribed comment may be automatically included in an e-mail that, for example, thanks the user for commenting.

While illustrative embodiments have been illustrated and described, it will be appreciated that various changes can be made therein without departing from the spirit and scope of the subject matter.

The embodiments of the invention in which an exclusive property or privilege is claimed are defined as follows:

1. A computer-readable medium on which data stored thereon are accessible by software which is being executed on a computer, comprising:
one or more data structures, each data structure associating a piece of inchoate user-created content with a user interface element connected with the software, each data structure persisting so as to allow retrieval after the user-created content is transformed from inchoate to formed whether or not a user leaves or returns to the user interface element after navigating away from the user interface element.

2. The computer-readable medium of claim 1, wherein each data structure includes an identifier attribute that contains a unique identifier.

3. The computer-readable medium of claim 2, wherein the unique identifier attribute is encoded with information selected from a group consisting essentially of an identity of the user, a company of the user, and the computer of the user.

4. The computer-readable medium of claim 1, wherein a data structure includes a piece of formed user-created content comprised of text and a corresponding piece of inchoate user-created content comprised of audio.

5. The computer-readable medium of claim 1, wherein a data structure includes a piece of formed user-created content selected from a group consisting essentially of images and videos.

6. The computer-readable medium of claim 1, wherein a data structure includes a piece of formed user-created content comprised of GPS data and further including a latitude attribute and a longitude attribute.

7. The computer-readable medium of claim 1, wherein a data structure includes a piece of formed user-created content comprised of time and further including a date attribute and a time attribute.

8. The computer-readable medium of claim 1, wherein each data structure includes a status attribute which is selected from a group consisting essentially of recorded, pending, preliminary, and done.

9. The computer-readable medium of claim 1, wherein each data structure is implemented using a language selected from a group consisting essentially of SGML, XML, text markup language, and binary markup language.

10. A method, comprising:
focusing on a user interface element of software being executed on a computer;
capturing a piece of inchoate user-created content initiated by a user; and
creating a data structure which associates the inchoate user-created content with the user interface element connected with the software, the data structure persisting so as to allow retrieval after the user-created content is transformed from inchoate to formed whether or not the user leaves or returns to the user interface element after navigating away from the user interface element.

11. The method of claim 10, further comprising requesting a unique identifier for the data structure from a server.

12. The method of claim 10, further comprising transmitting the inchoate user-created content to a server.

13. The method of claim 10, further comprising transforming the inchoate user-created content to the formed user-created content.

14. The method of claim 10, further comprising storing the inchoate user-created content to a data store.

15. The method of claim 14, further comprising recalling the inchoate user-created content stored in the data store.

16. A computer system, comprising:
a transcription computer on which a transcriptionist component executes;
a data and transcription server; and
a client computer on which a transcriber component and an application execute, the application including a user interface element, which can be focused to capture inchoate user-created content, the transcriber component creating a data structure which associates the inchoate user-created content with the user interface element connected with the application, the data structure persisting so as to allow retrieval after the user-created content is transformed by the transcriptionist component from inchoate to formed whether or not a user leaves or returns to the user interface element after navigating away from the user interface element.

17. The computer system of claim 16, further including a data and transcription database which records a request from the transcriber component for a unique identifier and further stores the inchoate user-created content transmitted to the data and transcription server from the transcriber component.

18. The computer system of claim 16, further comprising a user interface which executes on the client computer, the user interface selectively allowing the user to remove the data structure leaving only the formed user-created content in the user interface element, the user interface further selectively allowing the user to restore the data structure after removing it.

19. The computer system of claim 16, further comprising a content server which serves the application that includes a Web document.

20. The computer system of claim 19, wherein the content server includes an application that identifies the data structure that has a pending status and communicates with the data and transcription server to retrieve the formed user-created content even if the user never returns to the user interface element.
